(19) United States
(12) Patent Application Publication
(10) Pub. No.: US 2017/0262044 A1
(43) Pub. Date: Sep. 14, 2017

(54) INFORMATION PROCESSING DEVICE, INFORMATION PROCESSING METHOD, AND RECORDING MEDIUM

(71) Applicant: NEC Corporation, Tokyo (JP)

(72) Inventors: Takashi TAKENAKA, Tokyo (JP); Shuichi TAHARA, Tokyo (JP); Kenichi OYAMA, Tokyo (JP); Nobuharu KAMI, Tokyo (JP); Hiroto SUGAHARA, Tokyo (JP); Noboru SAKIMURA, Tokyo (JP); Kosuke NISHIHARA, Tokyo (JP); Naoki KASAI, Tokyo (JP)

(73) Assignee: NEC Corporation, Tokyo (JP)

(21) Appl. No.: 15/508,989

(22) PCT Filed: Sep. 7, 2015
(86) PCT No.: PCT/JP2015/004525

§ 371 Date: Mar. 6, 2017

(30) Foreign Application Priority Data
Sep. 10, 2014 (JP) 2014-183766

(51) Int. Cl. G06F 1/32

(52) U.S. Cl. CPC G06F 1/3287

(57) ABSTRACT

An information processing apparatus according to the present invention includes: a detection unit that detects detection information that is information indicating an external state of the apparatus; a communication unit that receives reception information that is a determination result given by another apparatus; and a control unit that calculates a first determination result that is a result acquired by determining a state of a surrounding of the apparatus based on the detection information and the reception information, transmits the first determination result to the another apparatus via the communication unit, and activates a necessary function for the detection unit or the communication unit and stops an unnecessary function thereof.

### TECHNICAL FIELD

The present invention relates to processing of information, and more particularly relates to an information processing apparatus, an information processing system, an information processing method, and a recording medium for detecting and processing external information.

### BACKGROUND ART

Nowadays, many sensors are installed in urban areas to collect peripheral situations or environment information. In general, an information processing apparatus connected to the sensors via a network centrally processes the information detected by the sensors.

However, detection information detected with a sensor includes uncertainty based on the detection precision of the sensor. In addition, in general, the sensor may include noise in the detection information. Therefore, determination made by the information processing apparatus using sensor information may include uncertainty.

Therefore, an information processing apparatus which processes sensor information performs determination or control by using a plurality of sensors in order to improve the precision of detection (see, for example, PLT1). Alternatively, the information processing apparatus performs determination or control by using information provided by sensors in another apparatus in order to improve the precision of the detection (see, for example, PLT2).

In order for many sensors to transmit information, the effectiveness of communication is needed. Therefore, the effectiveness of communication has been studied (see, for example, PLT3).

As the number of sensors increases, the power consumption of the whole system increases. That is, the power consumption of the entire system causes a problem. Therefore, in recent years, the power consumptions of sensors are desired to be reduced. The reduction in the power consumption also brings about an improvement in the maintainability of the sensor network, e.g., replacement of batteries. Therefore, a technique for reducing the power consumption of the sensor has been considered (see, for example, PLT4).

### CITATION LIST

### Patent Literature

[PLT 1]

[PLT 1] Japanese Patent Application Laid-Open No. H. 10 (1998)-104354

[PLT 2] Japanese Patent Application Laid-Open No. 2004-348683

[PLT 3] Japanese Patent Application Laid-Open No. 2007-251657

[PLT 4] Japanese Patent Application Laid-Open No. 2013-191156

### SUMMARY OF INVENTION

### Technical Problem

The technique described in PLT 1 improves the precision of detection by using a plurality of sensors. However, the sensor described in PLT 1 has a fixed function, and is not controlled for startup, stop, and the like. The technique described in PLT 1 uses a predetermined sensor. As described above, the technique described in PLT 1 has a problem that the power consumption may not be improved because the power consumption is not taken into consideration. In addition, the technique described in PLT 1 has a problem that it may not deal with a change in cooperation between sensors based on a failure and the like of a sensor.

The technique described in PLT 2 improves the operation of the apparatus by using the information from the sensor in another apparatus. However, the technique described in PLT 2 is not a technique for improving the operation of the sensor of the own apparatus. The technique described in PLT 2 is an invention that improves the different operation, such as cruising, from one of the sensor, by making use of the addition of the detection result of the sensor in another apparatus to the detection result of the sensor of the own apparatus. Therefore, the technique described in PLT 2 has a problem of unable to improve the detection precision of the sensor and unable to reduce the power consumption of the sensor.

In the technique described in PLT 3, a terminal declaring a representation transmits data as a representative. However, the technique described in PLT 3 needs communication between terminals in order to determine the representative. That is, the technique described in PLT 3 needs not only communication for notifying sensor information but also communication for determining the representative. As described above, the technique described in PLT 3 has a problem that it is necessary to perform the communication other than the notification of the sensor information.

In the technique described in PLT 4, a server that manages sensor modules of the entire system receives data from the sensor modules of the entire system, and determines a module group and a reference sensor module. In other words, the technique described in PLT 4 has a problem that it is necessary to provide the apparatus (server) for managing the sensor modules in addition to the apparatus for processing data of the sensors. Furthermore, the technique described in PLT 4 has a problem that it is necessary to perform communication to allow the server to manage the sensor modules.

It is an object of the present invention to solve the above problems and to provide an information processing apparatus, an information processing system, an information processing method, and a recording medium, for improving the detection precision of a sensor while reducing the power consumption without requiring an apparatus that manages the entire system.

### Solution to Problem

An information processing apparatus according to one aspect of the present invention includes: detection means for detecting detection information that is information indicating an external state of the apparatus; communication means for receiving reception information that is a determination result given by another apparatus; and control means for calculating a first determination result that is a result acquired by determining a state of a surrounding of the apparatus based on the detection information and the reception information, transmitting the first determination result to the another apparatus via the communication means, and activating a necessary function for the detection means or the communication means and stopping an unnecessary function thereof.

An information processing system according to one aspect of the present invention includes a plurality of the information processing apparatuses. The information processing apparatus includes: detection means for detecting detection information that is information indicating an external state of the apparatus; communication means for receiving reception information that is a determination result given by another apparatus; and control means for calculating a first determination result that is a result acquired by determining a state of a surrounding of the apparatus based on the detection information and the reception information, transmitting the first determination result to the another apparatus via the communication means, and activating a necessary function for the detection means or the communication means and stopping an unnecessary function thereof. At least some of the information processing apparatuses have an equivalent function in a predetermined period.

An information processing method according to one aspect of the present invention for causing an information processing apparatus includes: detecting detection information that is information indicating an external state of the apparatus; receiving reception information that is a determination result given by another apparatus; calculating a first determination result that is a result acquired by determining a state of a surrounding of the apparatus based on the detection information and the reception information, and transmitting the first determination result to the another apparatus; and switching a function in an element for executing at least one of detection of the detection information, reception of the reception information, and transmission of the first determination result.

A computer readable non-transitory recording medium according to one aspect of the present invention records a program. The program causes a computer to execute, in an information processing apparatus: processing of detecting detection information that is information indicating an external state of the apparatus; processing of receiving reception information that is a determination result given by another apparatus; processing of calculating a first determination result that is a result acquired by determining a state of a surrounding of the apparatus based on the detection information and the reception information, and transmitting the first determination result to the another apparatus; and processing of activating a necessary function in an element for executing at least one of the above processing and stopping an unnecessary function thereof.

### Advantageous Effects of Invention

Based on the present invention, the detection precision of a sensor can be improved while reducing the power consumption without requiring the apparatus that manages the entire system.

### BRIEF DESCRIPTION OF DRAWINGS

FIG. 1 is a block diagram showing an example of a configuration of an information processing apparatus according to a first example embodiment of the present invention.

FIG. 2 is a block diagram showing an example of a configuration of a detection unit according to the first example embodiment.

FIG. 3 is a block diagram showing an example of a configuration of a power supply unit according to the first example embodiment.

FIG. 4 is a block diagram showing an example of a configuration of a control unit according to the first example embodiment.

FIG. 5 is a block diagram showing an example of a configuration of an information processing system including the information processing apparatus according to the first example embodiment.

FIG. 6 is a block diagram showing an example of another configuration of a control unit according to the first example embodiment.

### DESCRIPTION OF EMBODIMENTS

Subsequently, an example embodiment of the present invention will be described with reference to the drawings.

Each drawing explains an example embodiment of the present invention. However, the present invention is not limited to the description in each drawing. The same reference numerals are denoted to similar configurations in each drawing, and redundant description therefor may be omitted in some cases.

In the drawings used in the following explanation, regarding a configuration of a portion not related to the description of the present invention, the description thereof may be omitted, and the drawing thereof may not be illustrated in some cases.

### First Example Embodiment

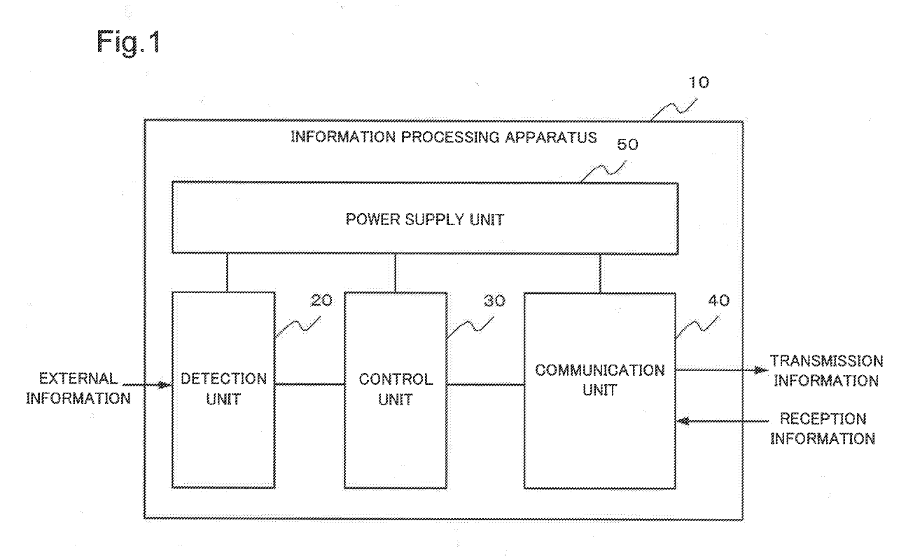

FIG. 1 is a block diagram showing an example of a configuration of an information processing apparatus 10 according to the first example embodiment of the present invention.

The information processing apparatus 10 includes a detection unit 20, a control unit 30, a communication unit 40, and a power supply unit 50.

The control unit 30 controls the operation of each constituent element of the information processing apparatus 10 based on information detected by the detection unit 20 (hereinafter referred to as “detection information”) and information received by the communication unit 40 (hereinafter referred to as “reception information”). The control unit 30 transmits information to another apparatus via the communication unit 40 as necessary.

The details of the operation of the control unit 30 will be explained later.

The detection unit 20 detects or collects external information (detection information) of the information processing apparatus 10. The detection unit 20 may detect a plurality of pieces of information (e.g., pieces of information at a plurality of places). In addition, the detection unit 20 may detect a plurality of types of information (e.g., sound, vibration, light, temperature, or humidity). Hereinafter, the function of the detection unit 20 may be referred to as a “first function” in some cases. In contrast to the first function of detection unit 20, the function of the control unit 30 may be referred to as a “second function” in some cases.

The detection unit 20 may include a detector (sensor) and output detection information. Alternatively, the detection unit 20 may acquire detection information from an external detector (sensor). However, in the following explanation, as an example, the detection unit 20 is assumed to include a sensor.

Further, the detection unit 20 controls the operation of the sensor based on a command of the control unit 30. For example, when the detection unit 20 includes a plurality of sensors, the detection unit 20 may select the sensor to be used based on the command of the control unit 30. More specifically, the detection unit 20 may perform control to limit the number of sensors operating at the same time. For example, the detection unit 20 may operate any one of the sensors. Alternatively, the detection unit 20 may simultaneously operate a plurality of sensors.

The detection unit 20 may stop supplying power supply to an unused sensor. That is, the detection unit 20 may control a supply of power supply to the sensor based on the command of the control unit 30.

Alternatively, the detection unit 20 may control the operation of the sensor (for example, a detection range or a detection interval) based on the command of the control unit 30.

The detection unit 20 may control the sensor based on the power supply status of the power supply unit 50. For example, when the power that can be supplied by the power supply unit 50 to the detection unit 20 decreases, the detection unit 20 may stop a sensor consuming large power and may switch the sensor to a sensor consuming less power. That is, the detection unit 20 may control the power supplied to the detection unit 20 by the power supply unit 50.

The control unit 30 may command switching of the sensor used for the detection unit 20 based on the power supply status of the power supply unit 50. This operation can realize the function the same as the operation of the detection unit 20 described above. That is, the control unit 30 may control the power supplied to the detection unit 20 by the power supply unit 50.

An example of specific constituent elements and operations of the detection unit 20 will be described with reference to the drawings.

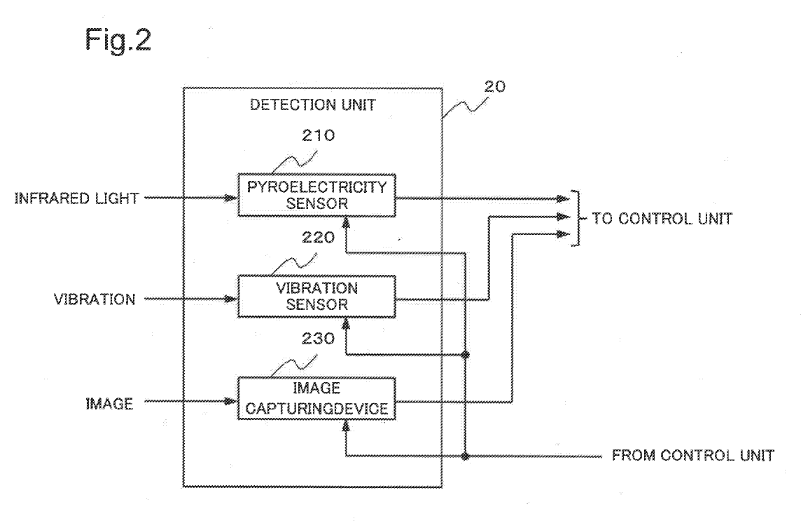

FIG. 2 is a block diagram showing an example of the configuration of the detection unit 20 according to the present example embodiment.

The detection unit 20 shown in FIG. 2 includes a pyroelectricity sensor 210, a vibration sensor 220, and an image capturing device 230. However, the sensor shown in FIG. 2 is an example. The detection unit 20 may include other sensors. The detection unit 20 may include one or two sensors, and may include more than three sensors. In FIG. 2, the power from the power supply unit 50 is omitted.

The pyroelectricity sensor 210 detects infrared light. The pyroelectricity sensor 210 consumes less power than other sensors described later. However, the pyroelectricity sensor 210 has a low level of precision in detection, e.g., discrimination of a detection target. In other words, the detection of the pyroelectricity sensor 210 has a low level of certainty (a high level of uncertainty).

The vibration sensor 220 detects vibration. The vibration sensor 220 can classify the types of the vibration sources to some extent based on the state of vibration (vibration waveform or period). That is, the vibration sensor 220 has a higher detection precision (a higher level of certainty or a lower level of uncertainty) than the pyroelectricity sensor 210. However, the vibration sensor 220 generally consumes larger power than the pyroelectricity sensor 210.

The image capturing device 230 acquires the image information. The image capturing device 230 is, for example, a CMOS (Complementary Metal Oxide Semiconductor) image sensor, a CCD (Charge Coupled Device) image sensor, or a general camera device. The image capturing device 230 can analyze the target object of a captured image in details by using image processing. Therefore, the image capturing device 230 has a higher level of detection precision (a higher level of certainty or a lower level of uncertainty) than the other sensors. However, the image capturing device 230 generally consumes larger power than the other sensors.

As described above, in general, the detection precision of a sensor and the power consumption are often proportional. Therefore, when the detection unit 20 includes a plurality of sensors, the control unit 30 controls the detection unit 20 so as to satisfy a predetermined condition (a detection precision or a power consumption).

The communication unit 40 receives, from another apparatus, reception information related to the detection state of another apparatus. The communication unit 40 transmits, to another apparatus, the determination result (hereinafter referred to as “transmission information”) determined by the control unit 30 based on the detection information and the reception information. Hereinafter, the function of the communication unit 40 may be referred to as a “third function” in some cases.

The communication unit 40 may change the function of communication based on the control of the control unit 30. For example, the control unit 30 may stop the communication unit 40 when the communication is not needed. Alternatively, when the communication unit 40 includes a plurality of communication means, the control unit 30 may give a command of required communication means to the communication unit 40 and cause the communication unit 40 to use the predetermined communication means. These operations are intended to by the control unit 30 to control the supply of power in the power supply unit 50 to the communication unit 40.

The communication method of the communication unit 40 of the present example embodiment is not particularly limited. The communication method of the communication unit 40 may be either two-way communication or one-way communication. Further, as described above, the communication unit 40 may include a plurality of communication means, and may switch the communication means based on the command of the control unit 30. For example, the communication unit 40 may use a wireless LAN (Local Area Network) or ZigBee® as a communication method. Therefore, the detailed description about the communication unit 40 will be omitted.

The communication unit 40 preferably includes communication means capable of communicating within a predetermined range. However, the communicable range of the communication unit 40 need not be fixed. The communicable range of the communication unit 40 may change. Furthermore, when the communicable range is limited and the operation of the control unit 30, which will be described later in details, can be realized, the communication unit 40 may use a wired communication without limiting to wireless communication.

Hereinafter, an apparatus capable of communication included in the communicable range of the communication unit 40 will be referred to as a “nearby apparatus”. The communicable range does not have to be fixed as described above, and may change based on the communication state and the environment condition. The installation positions of the information processing apparatus 10 of the present example embodiment and the nearby apparatus do not have to be fixed. Furthermore, in general, the apparatus may become inoperable due to a failure or a power shortage. Therefore, the apparatus include in the nearby apparatus to the information processing apparatus 10 of the present example embodiment may change. The nearby apparatuses generally include a plurality of apparatuses. Therefore, cooperation between the information processing apparatus 10 and the nearby apparatus to the information processing apparatus 10 achieves “group control”.

The power supply unit 50 supplies power to each constituent element of the information processing apparatus 10. Hereinafter, the function of the power supply unit 50 may be referred to as a “fourth function” in some cases.

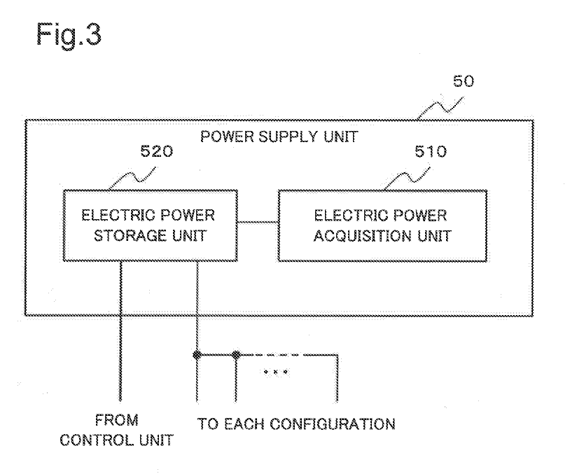

FIG. 3 is a block diagram showing an example of the configuration of the power supply unit 50 according to the present example embodiment.

The power supply unit 50 includes an electric power acquisition unit 510 and an electric power storage unit 520. The power supply unit 50 shown in FIG. 3 includes one electric power acquisition unit 510 and one electric power storage unit 520. However, this is an example. The power supply unit 50 may include a plurality of the electric power acquisition units 510 or the electric power storage units 520 with similar constituent elements or similar functions. Alternatively, the power supply unit 50 may include a plurality of electric power acquisition units 510 or electric power storage units 520 of different types.

The electric power acquisition unit 510 acquires electric power from an energy source outside of the apparatus. However, the electric power acquisition unit 510 according to the present example embodiment preferably includes electric power acquisition means which does not require an external electric power supply device. Here, the electric power acquisition means which does not require the external electric power supply device includes, for example, solar cells, a wind power generator, or a vibration generator.

However, this does not exclude the case where the power supply unit 50 receives electric power from the external electric power supply device. The electric power acquisition unit 510 may receive electric power from the external electric power supply device. For example, the electric power acquisition unit 510 may receive the supply of the electric power by using non-contact electric power transmission (wireless power supply).

The electric power storage unit 520 stores electric power acquired by the electric power acquisition unit 510 and supplies the electric power to each constituent element. The electric power storage unit 520 preferably includes, as storage means of electric power, means that need not be replaced. For example, the electric power storage unit 520 is preferably a capacitive device such as an electric double layer capacitor or a hybrid device of a storage battery such as a lithium ion capacitor and a capacitor. However, the electric power storage unit 520 may be a general storage battery.

Further, the power supply unit 50 may include an electric power storage unit 520 (e.g., a dry cell battery) that may not be charged with additional electric power but provides electric power included in advance. In this case, the power supply unit 50 may not include the electric power acquisition unit 510. In addition, the electric power storage unit 520 may control the electric power provided to each constituent element based on the command of the control unit 30.

Subsequently, the configuration and the operation of the control unit 30 will be described in details.

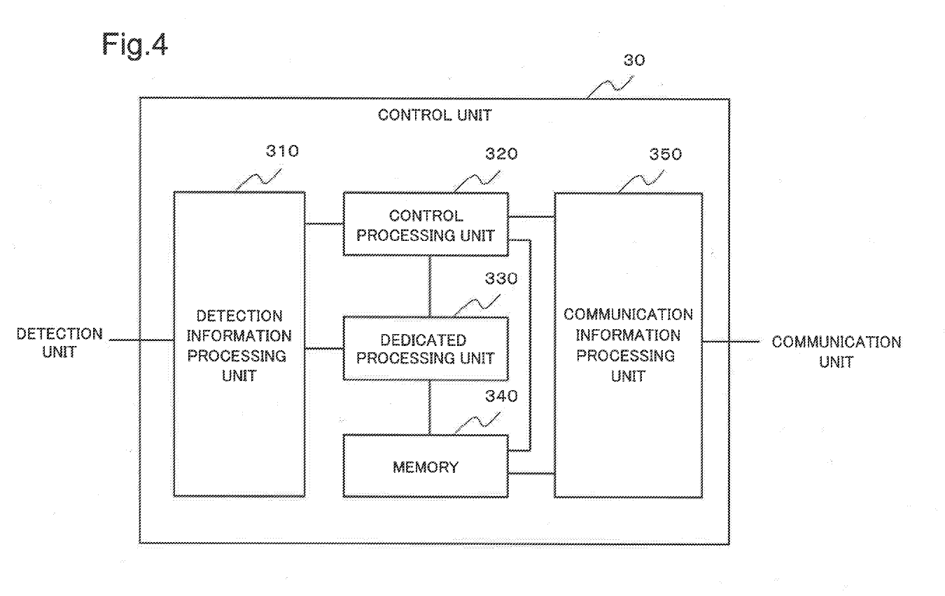

FIG. 4 is a block diagram showing an example of the configuration of the control unit 30 according to the present example embodiment.

The control unit 30 includes a detection information processing unit 310, a control processing unit 320, a dedicated processing unit 330, a memory 340, and a communication information processing unit 350. To avoid the complication, in FIG. 4, illustration of a power supply from the power supply unit 50 is omitted.

The control processing unit 320 processes the control of each unit included in the control unit 30. The control processing unit 320 is realized using a general-purpose computer such as a CPU (Central Processing Unit), for example.

The detection information processing unit 310 receives a signal or information that is output by the sensor included in the detection unit 20, changes the signal or the information into information that can be processed by the control processing unit 320 and the dedicated processing unit 330, and outputs the changed information. For example, when the sensor included in the detection unit 20 outputs an analog signal, the detection information processing unit 310 includes an AD (Analog Digital) converter, and converts the analog signal into a digital signal or digital information. Further, the detection information processing unit 310 transmits, to the detection unit 20, a command of the control processing unit 320 or the dedicated processing unit 330 for the detection unit 20.

The dedicated processing unit 330 executes predetermined processing based on the command of the control processing unit 320. The dedicated processing unit 330 is, for example, a DSP (Digital Signal Processor), GPU (Graphic Processing Unit), or FPU (Floating Point Unit). Alternatively, the dedicated processing unit 330 may be a circuit for specific signal processing.

However, the control processing unit 320 may include the dedicated processing unit 330. Alternatively, the control processing unit 320 may implement processing equivalent to the function of the dedicated processing unit 330, by using an operation based on a program. In this case, the control unit 30 may not include the dedicated processing unit 330 serving as individual hardware.

The communication information processing unit 350 processes communication (transmission and reception) with the communication unit 40.

The memory 340 is a storage unit in which each constituent element stores data required for processing. The memory 340 preferably holds data even when an electric power is not supplied from the power supply unit 50. The memory 340 may be realized by using a flash memory or an EEPROM (Electrically Erasable Programmable Read Only Memory), for example. Alternatively, the memory 340 may be implemented using a newly-rising type non-transitory memory. Here, the newly-rising type non-transitory memory is an FeRAM (Ferroelectric Random Access Memory) or an MRAM (Magnetic Random Access Memory), for example. Alternatively, the newly-rising type non-transitory memory is a PRAM (Phase-change Random Access Memory) or an ReRAM (Resistive Random Access Memory).

The memory 340 holds an IPL (Initial Program Loader) or an execution program for the control processing unit 320 and the dedicated processing unit 330.

Subsequently, the operation of the control unit 30 will be described. The control unit 30 executes the following operations with a predetermined time interval or when a predetermined condition is detected. Here, the predetermined condition is, for example, a condition for a time, detection information from the detection unit 20, or the reception information from the communication unit 40.

The control unit 30 determines the state of surrounding of the information processing apparatus 10 based on the detection information detected by the detection unit 20 and the reception information which is received by the communication unit 40 and is a determination result of the nearby apparatus. The operation of control unit 30 will be described in detail later. Here, the determination of the state of the surrounding means that the control unit 30 determines whether an event satisfying the predetermined condition has occurred based on the detection information and the reception information. For example, when the state of the surrounding is an intrusion of a person, the control unit 30 determines whether a person has intruded into the surrounding of the information processing apparatus 10 (a predetermined range from the information processing apparatus 10) based on the detection information and the reception information. Here, the predetermined range from the information processing apparatus 10 may be a range including the nearby apparatus that transmits the reception information. Hereinafter, this determination result will be referred to as a first “determination result”. The control unit 30 calculates (determines) the first determination result based on the detection information or the reception information. Here, the control unit 30 may calculate the determination result based on either the detection information or the reception information. In other words, the control unit 30 calculates the determination result even when it is impossible to receive either of the detection information or the reception information.

As already explained, the detection information of the detection unit 20 includes uncertainty. This is also applicable to the nearby apparatus. Therefore, the reception information which is the determination result of the nearby apparatus includes some degree of uncertainty.

However, as compared with the case of the determination made independently using each piece of information, the control unit 30 can calculate the determination result with an improved level of certainty based on the detection information including some degree of uncertainty and the reception information including some degree of uncertainty. In other words, the control unit 30 can realize an improvement in the detection precision.

The control unit 30 transmits the determination result to the nearby apparatus via the communication unit 40.

Furthermore, the control unit 30 commands the detection unit 20 or the communication unit 40 to change the operation based on the determination result as necessary. For example, the control unit 30 may switch (change) the circuits operating in the detection unit 20 or the communication unit 40. That is, the control unit 30 may change the hardware used by the detection unit 20 or the communication unit 40. For example, when the detection unit 20 or the communication unit 40 includes an FPGA (Field Programmable Gate Array), the control unit 30 may change the configuration of the FPGA. Alternatively, when the detection unit 20 or the communication unit 40 includes a plurality of circuits, the control unit 30 may switch the circuits.

The operation of the above described control unit 30 will be described in more details.

For example, when the control unit 30 receives the detection information from the detection unit 20, the control unit 30 determines the state of the surrounding of the information processing apparatus 10 based on the detection information detected by the detection unit 20. For example, when the pyroelectricity sensor 210 of the detection unit 20 detects infrared light, the control unit 30 determines that an object emitting infrared light is approaching the information processing apparatus 10.

After making the determination, the control unit 30 transmits the determination result to the nearby apparatus via the communication unit 40.

At this occasion, the control unit 30 does not need a response from the nearby apparatus.

Then, the control unit 30 commands the detection unit 20 or the communication unit 40 to change the operation based on the determination result.

For example, when the control unit 30 determines that an object is approaching based on the detection information of the infrared light of the pyroelectricity sensor 210, the control unit 30 commands the detection unit 20 to activate the vibration sensor 220 in order to improve the precision in the determination of the object. Further, when the control unit 30 determines that a person is approaching based on the vibration detection information of the vibration sensor 220, for example, the control unit 30 commands the detection unit 20 to activate the image capturing unit 230 in order to distinguish a person.

Alternatively, when the control unit 30 determines that an object is approaching based on the detection information of the infrared light of the pyroelectricity sensor 210, the transmission of the determination results to another apparatus is highly likely to continue. Therefore, the control unit 30 commands the communication unit 40 to secure the communication channel, for example. When the control unit 30 determines that a person is approaching based on the vibration detection information of the vibration sensor 220, it is highly likely the determination with a high degree of precision is needed. Therefore, for example, the control unit 30 commands the communication unit 40 to establish communication with a wide communication range or communication at a high speed.

When the communication unit 40 receives the determination result of the nearby apparatus, the control unit 30 uses the determination result of the nearby apparatus in addition to the detection information of the detection unit 20 to determine the state of the surrounding of the information processing apparatus 10.

For example, the control unit 30 may make a determination based on the reception state of the reception information from the nearby apparatus. More specifically, for example, when the frequency of the reception information from the nearby apparatus increases per unit time, an object is determined to be approaching in the vicinity of the information processing apparatus 10. Then, the control unit 30 commands the detection unit 20 or the communication unit 40 to change the operation based on the determination result. For example, the control unit 30 starts the operation of any one of the sensors provided in the detection unit 20.

Alternatively, when the reception information is received from the nearby apparatus in a predetermined direction, it is highly likely that the object from that direction approaches. Therefore, the control unit 30 may command the detection unit 20 to activate a sensor in that direction, or activate a sensor in that direction having a high degree of detection precision.

Alternatively, the control unit 30 may make a determination based on the content of the reception information from the nearby apparatus. For example, when information given from the nearby apparatus includes information indicating that a person is detected, the control unit 30 determines that a person is approaching in the vicinity of the information processing apparatus 10. Then, for example, the control unit 30 commands the detection unit 20 to activate the image capturing device 230.

Alternatively, when the control unit 30 receives a portion of the reception information from the nearby apparatus, the control unit 30 may use the portion of the reception information that has been received. For example, when the communication unit 40 uses packet communication, the control unit 30 may use the reception information included in the packet that has been received. However, in order to ensure the reliability, the control unit 30 does not need to use partial reception information.

As described above, the control unit 30 determines the state of the surrounding by using the determination result of the nearby apparatus that can be received via the communication unit 40 in addition to the detection information of the detection unit 20. Then, the control unit 30 transmits the determination result to the nearby apparatus via the communication unit 40.

The information processing apparatus 10 may stop either one of the detection unit 20 or the communication unit 40, and active remaining either one of the detection unit 20 or the communication unit 40 as necessary.

For example, the information processing apparatus 10 may activate the detection unit 20 in advance. Then, the control unit 30 may activate the communication unit 40 based on detection information from the detection unit 20. For example, when an approach of the object is detected with the pyroelectricity sensor 210, the control unit 30 may activate the communication unit 40 in order to receive the reception information which is the determination result of the nearby apparatus. Then, the control unit 30 may stop the communication unit 40 when neither the reception information of the nearby apparatus nor the detection information of the detection unit 20 no longer indicates that the object is approaching.

Alternatively, the information processing apparatus 10 may activate the communication unit 40 in advance. Then, the control unit 30 may activate the detection unit 20 based on the reception information from the communication unit 40. For example, the control unit 30 may activate the detection unit 20 when the control unit 30 receives reception information indicating an approach of an object from the nearby apparatus. Then, the control unit 30 may stop the detection unit 20 when neither the detection information of the detection unit 20 nor the reception information from the communication unit 40 no longer indicate that the object is approaching.

Further, the information processing apparatus 10 may switch the constituent element (the detection unit 20 or the communication unit 40) to be stopped.

As described above, the information processing apparatus 10 may change the function based on the detection information and the reception information.

Further, the control unit 30 determines whether the detection information and the reception information, or the first determination result satisfies a predetermined condition (hereinafter referred to as a “comprehensive determined notification condition”). Then, when the comprehensive determined notification condition is satisfied, the control unit 30 calculates a second determination result (hereinafter referred to as a “comprehensive determination”), and transmits the comprehensive determination to a predetermined apparatus (hereinafter referred to as a “comprehensive determination notification destination apparatus”) by using the communication unit 40 or communication means not shown.

For example, the information processing apparatus 10 stores information about a suspicious person. Then, the control unit 30 calculates the probability of being a suspicious person based on the image recognition result of the image capturing device 230 in the detection unit 20 and the recognition result included in the reception information given by the nearby apparatus. Here, the image recognition result in the control unit 30 is a result acquired by the control unit 30 determining whether an image captured by the image capturing device 230 is an image of a suspicious person. The recognition result included in the reception information is a similar determination result included in the reception information. The probability of being a suspicious person is a ratio of a cause considered to be due to a suspicious person with respect to the causes that can be considered for the recognition result. For example, when the control unit 30 uses, as the recognition result, a degree of match (correlation coefficient) between the captured image and the image of the suspicious person, the control unit 30 calculates, as the probability, a degree of match (correlation coefficient) between pixels in the captured image and the image of the suspicious person. More specifically, the control unit 30 calculates, as the detection information, the degree of match (correlation coefficient) between the image of the image capturing device 230 and the image of the suspicious person. Then, the control unit 30 calculates, as probability, a predetermined weighted average of the degree of match (correlation coefficient) of the calculated detection information and the degree of match (correlation coefficient) of the reception information. When the probability is larger than a predetermined value (for example, a probability of 80%), the information processing apparatus 10 notifies a determination result (for example, detection of a suspicious person) to the comprehensive determination notification destination apparatus (for example, an alarm device).

As described above, the information processing apparatus 10 can realize operations such as reporting even if a management apparatus is not included in the system including the information processing apparatus 10.

Hereinafter, an information processing system 80 including a plurality of information processing apparatuses 10 thus configured will be described.

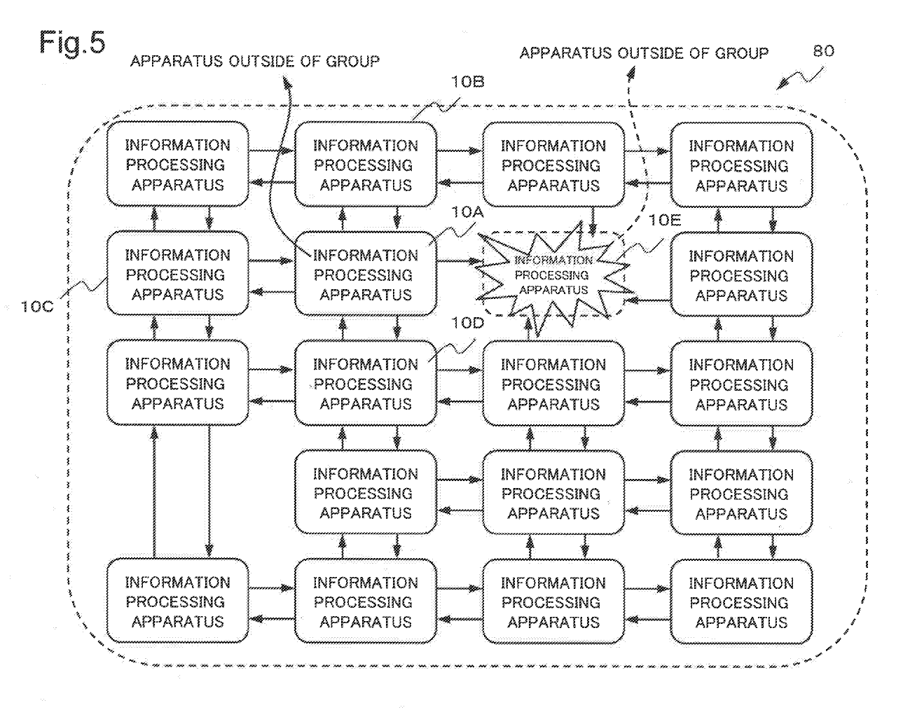

FIG. 5 is a block diagram showing an example of the configuration of the information processing system 80.

The information processing system 80 includes an information processing apparatus 10A as an apparatus including the same function as that of the information processing apparatus 10. Further, the information processing system 80 includes an information processing apparatus 10B, an information processing apparatus 10C, an information processing apparatus 10D, and an information processing apparatus 10E as nearby apparatuses to the information processing apparatus 10A. As described above, the information processing system 80 includes the information processing apparatus 10 as a group. However, the nearby apparatus in FIG. 5 is an example. The nearby apparatuses according to the present example embodiment may be less than four apparatuses, or may be more than four apparatuses.

As already explained, the number of nearby apparatuses may change, or the positions of the nearby apparatuses may change. This also applies to the information processing apparatus 10 included in the information processing system 80. In other words, as the time elapses, the number or the positions of apparatuses communicable with the information processing apparatuses 10 included in the information processing system 80 may change. Further, as the time elapses, the number of information processing apparatuses 10 included in the information processing system 80 may change, or the positions of the information processing apparatuses 10 included in the information processing system 80 may change

The above described comprehensive determination notification destination apparatus is an apparatus other than the group of the information processing systems 80.

In the case of the normal state, the information processing apparatus 10A determines the state of surrounding based on, in addition to the detection information of the detection unit 20, the reception information, i.e., the determination results of the nearby apparatuses (the information processing apparatus 10B, the information processing apparatus 10C, the information processing apparatus 10D, and the information processing apparatus 10E). For example, it is assumed that the information processing apparatus 10A has received the reception information from the information processing apparatus 10B and the information processing apparatus 10C. The control unit 30 of the information processing apparatus 10A calculates reliability of the detection result given by the detection unit 20 of own apparatus and the reception information from the information processing apparatus 10B and the information processing apparatus 10C. Here, the information processing apparatus 10A holds the reliabilities for the information processing apparatus 10B and the information processing apparatus 10C in advance. Then, the information processing apparatus 10A calculates, as the reliability of the reception information, a value acquired by multiplying the reception information from the information processing apparatus 10B and the information processing apparatus 10C by the reliability of each apparatus, and summing them. However, the information processing apparatus 10A may receive, as information included in the reception information, the reliability of entire or partial apparatuses. The case where the result of detection is “detected” will be explained in more details by using specific values. As the values of a specific result, the value of “detected” in the reception information is assumed to be defined as “1”, and the value of “not detected” is assumed to be defined as “0”. It is assumed that the information processing apparatus 10A holds “80%” as the reliability of the information processing apparatus 10B, and “30%” as the reliability of the information processing apparatus 10C. Further, it is assumed that the information processing apparatus 10A receives “detected” as the reception information of the information processing apparatus 10C and receives “not detected” as the reception information of the information processing apparatus 10B. In this case, the information processing apparatus 10A calculates “the reliability=(1×0.3+0×0.8)/(0.3+0.8)≅0.27” as the reliability for “detected” in the reception information. Alternatively, it is assumed that the information processing apparatus 10 receives “not detected” as the reception information of the information processing apparatus 10C and receives “detected” as the reception information of the information processing apparatus 10B. In this case, the information processing apparatus 10A calculates “the reliability=(0×0.3+1×0.8)/(0.3+0.8)≈0.73” as the reliability for “detected” in the reception information. Alternatively, it is assumed that the information processing apparatus 10 receives “detected” as the reception information of the information processing apparatus 10C and the information processing apparatus 10B. In this case, the information processing apparatus 10A calculates “the reliability=(1×0.3+1×0.8)/(0.3+0.8)=1.0 as the reliability of “detected” in the reception information. Then, the control unit 30 of the information processing apparatus 10A calculates the probability of the detection result of the detection unit 20 in the own apparatus, e.g., the probability of being a suspicious person, in view of the calculated reliability. More specifically, the detection unit 20 adopts, as the probability of the detection result, an average value or a predetermined weighted average of the detection result of the own apparatus and the result of the reception information multiplied by the reliability. When the probability is more than a predetermined value, the control unit 30 of the information processing apparatus 10A notifies a determination result (for example, a detection of a suspicious person) to the comprehensive determination notification destination apparatus.

Here, the information processing apparatus 10E is assumed to be unable to communicate with the outside due to a failure or electric power shortage.

However, the information processing apparatus 10A can perform operation based on the detection information of the detection unit 20 of the own apparatus and the reception information which is the determination result given by apparatuses capable of communication (the information processing apparatus 10B, the information processing apparatus 10C, and the information processing apparatus 10D). For example, it is assumed that the information processing apparatus 10A receives the reception information from the information processing apparatus 10B. The control unit 30 of the information processing apparatus calculates the reliability of the detection result of the detection unit 20 of the own apparatus and the reception information given by the information processing apparatus 10B. Then, the control unit 30 of the information processing apparatus 10A calculates the probability of the detection result of the detection unit 20 in the own apparatus, e.g., the probability of being a suspicious person, in view of the calculated reliability and considering the fact that the information processing apparatus 10E is unreachable. Here, “considering the fact that the information processing apparatus 10E is unreachable” means that the control unit 30 corrects the calculated probability by using a predetermined operation (for example, adding a predetermined value) when the information processing apparatus 10E is unreachable. The predetermined operation (for example, addition of a value) is set in control unit 30 in advance. In other words, as already described above, the control unit 30 of the information processing apparatus 10A calculates the probability based on the detection result of the own apparatus and the reception information. Furthermore, when the information processing apparatus 10E is unreachable, the control unit 30 calculates the probability by applying a predetermined operation (for example, an addition of a value) to the calculated probability. However, the operation performed by considering the fact that the information processing apparatus 10E is unreachable is not limited to the above. For example, when the information processing apparatus 10E is unreachable, the control unit 30 may apply a predetermined operation (for example, a change with a predetermined ratio) to the reliability for the reception information. When the probability is more than a predetermined value, the control unit 30 of the information processing apparatus 10A notifies the determination result (for example, detection of a suspicious person) to the comprehensive determination notification destination apparatus. Furthermore, even if the information processing apparatus 10A can communicate with none of the nearby apparatuses, the information processing apparatus 10A can perform operation based on the detection information of the detection unit 20 of the own apparatus. This also applies to other apparatuses (the information processing apparatus 10B, the information processing apparatus 10C, the information processing apparatus 10D, and the information processing apparatus 10E). For example, an apparatus having the malfunctioned communication with other apparatuses (the information processing apparatus 10E explained above) can transmit the determination result to the comprehensive determination notification destination apparatus, when the detection information of the detection unit 20 of the own apparatus satisfies the comprehensive determination notification condition and the information processing apparatus 10E can communicate with the comprehensive determination notification destination apparatus.

As already explained, the information processing apparatuses 10 included in the information processing system 80 may change their functions. In addition, the information processing apparatuses 10 included in the information processing system 80 may respectively have different functions (for example, detection information). However, at least some of the information processing apparatuses 10 included in the information processing system 80 may have the same functions in the initial state. When the information processing apparatuses 10 having the same functions are used, the developer of the information processing system 80 can reduce the cost for developing and manufacturing the information processing apparatuses 10.

At least some of the information processing apparatuses 10 included in the information processing system 80 may operate in synchronization with a predetermined signal or timing. In this case, in the range including the information processing apparatus 10 in synchronization, the information processing system 80 can reduce the uncertainty based on a difference in the detection time of the detection unit 20 in each apparatus.

(Explanation about Advantages)

Subsequently, the advantages of the present example embodiment will be described.

As described above, the information processing apparatus 10 of the first example embodiment can achieve the advantages that an apparatus for managing the system is not required.

The reasons for this are as follows.

This is because the control unit 30 of the information processing apparatus 10 can determine the state of surrounding based on the detection information detected by the detection unit 20 and the reception information received by the communication unit 40 from another apparatus. Furthermore, this is because the information processing apparatus 10 satisfying the comprehensive determination notification condition can execute the notification to the comprehensive determination notification destination apparatus.

Furthermore, the information processing apparatus 10 can achieve the advantages of improving the detection precision of the sensor while reducing the consumed electric power.

The reasons for this are as follows.

First, the information processing apparatus 10 does not require communication for management as described above, and therefore, the communication cost can be reduced.

Further, the control unit 30 determines the state of surrounding based on, in addition to the detection information of the detection unit 20, the reception information that could be received by the communication unit 40. Therefore, the control unit 30 can realize a determination with a higher degree of precision than the determination based on the detection information of the detection unit 20. Further, the control unit 30 controls the operations of the detection unit 20 and the communication unit 40 based on the determination result. That is, this is because the control unit 30 causes the functions needed for the determination by the detection unit 20 and the communication unit 40 to be operated, and stops unnecessary operations, so that the consumed electric power can be reduced.

(Modification)

The information processing apparatus 10 described above is configured as follows.

For example, each constituent element of the information processing apparatus 10 may be configured with a hardware circuit.

The information processing apparatus 10 may be configured using a plurality of information processing apparatuses in which the respective constituent elements of the information processing apparatus 10 are connected via a network or a bus.

The information processing apparatus 10 may be configured in such a manner that a plurality of constituent elements are made with a piece of hardware.

The control unit 30 of the information processing apparatus 10 may be realized as a computer apparatus including a CPU, a ROM (Read Only Memory), and a RAM (Random Access Memory). In addition to the above constituent elements, the control unit 30 may also be realized as a computer apparatus further including an IOC (input/output connection circuit) and an NIC (network interface circuit).

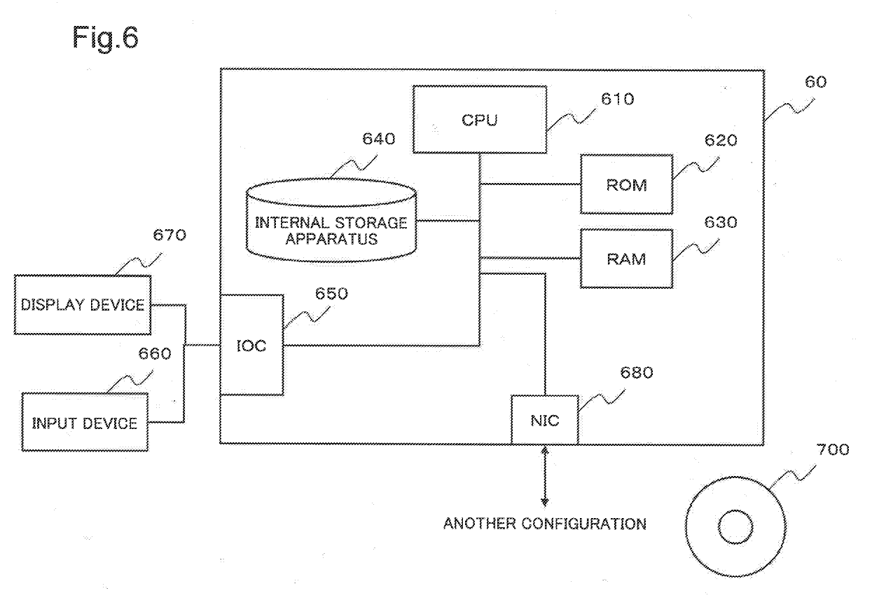

FIG. 6 is a block diagram showing an example of a configuration of a control unit 60 according to the present modification.

The control unit 60 includes a CPU 610, a ROM 620, a RAM 630, an internal storage apparatus 640, an IOC 650, and an NIC 680, and constitutes a computer apparatus. Furthermore, the control unit 60 may include a co-processor not shown as the dedicated processing unit 330.

The CPU 610 reads a program from the ROM 620. Then, the CPU 610 controls the RAM 630, the internal storage apparatus 640, the IOC 650, and the NIC 680 based on the read program. Then, the computer including the CPU 610 controls these constituent elements and implements the each function of the control unit 30 shown in FIG. 1. More specifically, the CPU 610 implements each function of the control processing unit 320 shown in FIG. 4.

The CPU 610 may realize some of the functions of the detection unit 20, the communication unit 40, and the power supply unit 50 shown in FIG. 1. The CPU 610 may be a general-purpose computer or a dedicated computer, and is not particularly limited.

When the CPU 610 realizes each function, the CPU 610 may use the RAM 630 or the internal storage apparatus 640 as a temporary storage for the program. In other words, the RAM 630 or the internal storage apparatus 640 may operate as the memory 340.

The CPU 610 may read a program included in a storage medium 700 storing the program in a computer readable manner by using a storage medium reading apparatus not shown. Alternatively, the CPU 610 may receive a program from an external apparatus not shown through the NIC 680, store the program in the RAM 630, and operate based on the stored program.

The ROM 620 stores the program executed by the CPU 610 and fixed data. The ROM 620 is for example, a P-ROM (Programmable-ROM) or a flash ROM.

The RAM 630 temporarily stores the program executed by the CPU 610 and data. The RAM 630 is, for example, a D-RAM (Dynamic-RAM).

The internal storage apparatus 640 stores data stored by the control unit 60 for a long period of time and a program. In addition, the internal storage apparatus 640 may operate as a temporary storage apparatus for the CPU 610. The internal storage apparatus 640 is, for example, a hard disk apparatus, a magneto-optical disk apparatus, an SSD (Solid State Drive), or a disk array apparatus. Considering the consumed electric power, the control unit 60 may not include the internal storage apparatus 640.

Here, the ROM 620 and the internal storage apparatus 640 are non-transitory storage media. On the other hand, the RAM 630 is a transitory storage medium or a storage medium of the above-mentioned newly-rising type non-transitory memory. The CPU 610 can operate based on the program stored in the ROM 620, the internal storage apparatus 640, or the RAM 630. That is, the CPU 610 can operate using a non-transitory storage medium or a transitory storage medium.

The IOC 650 mediates data between the CPU 610 and an input device 660 and between the CPU 610 and a display device 670. The IOC 650 may operate as the detection information processing unit 310. The IOC 650 is, for example, an IO interface card or a USB (Universal Serial Bus) card.

The input device 660 is a device which receives an input command from the operator of the control unit 60. The input device 660 is, for example, a keyboard, a mouse, or a touch panel.

The display device 670 is a device which displays information to the operator of the control unit 60. The display device 670 is, for example, a liquid crystal display.

Considering the consumed electric power, the control unit 60 may not include the input device 660 and the display device 670. In this case, when the user needs to perform an operation for maintenance or the like, the user may connect the input device 660 and the display device 670 to the IOC 650 and operate the control unit 60.

The NIC 680 relays an exchange of data with an external apparatus not shown via a network. The NIC 680 may operate as the communication information processing unit 350 or the communication unit 40. The NIC 680 is, for example, a wireless LAN card.

Considering the consumed electric power, the control unit 60 may not include the IOC 650 in addition to the input device 660 and the display device 670. In this case, when the user needs to perform an operation for maintenance or the like, the user may connect the input device 660 and the display device 670 via the NIC 680 to operate the control unit 60.

The control unit 60 thus configured can achieve the same advantages as that of the control unit 30.

This is because the CPU 610 of the control unit 60 can realize similar functions as those of the control unit 30 based on the program.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-183766, filed on Sep. 10, 2014, the disclosure of which is incorporated herein in its entirety by reference.

### INDUSTRIAL APPLICABILITY

The present invention can be used for crime prevention purposes such as facility surveillance, predictive notification for emergency situations in public infrastructures and the like (factories, highways, or bridges), or for guiding visitors in facilities and the like.

### REFERENCE SINGS LIST

10 Information processing apparatus
20 Detection unit
30 Control unit
40 Communication unit
50 Power supply unit
60 Control unit
210 Pyroelectricity sensor
220 Vibration sensor
230 Image capturing device
310 Detection information processing unit
320 Control processing unit
330 Dedicated processing unit
340 Memory
350 Communication information processing unit
510 Electric power acquisition unit
520 Electric power storage unit
610 CPU
620 ROM
630 RAM
640 Internal storage apparatus
650 IOC
660 Input device
670 Display device
680 NIC
700 Storage medium

1. An information processing apparatus comprising:
a detection unit that detects detection information that is information indicating an external state of the apparatus;
a communication unit that receives reception information that is a determination result given by another apparatus; and
a control unit that calculates a first determination result that is a result acquired by determining a state of a surrounding of the apparatus based on the detection information and the reception information, transmits the first determination result to the another apparatus via the communication unit, and activates a necessary function for the detection unit or the communication unit and stops an unnecessary function thereof.

2. The information processing apparatus according to claim 1, wherein
when the control unit does not receive either one of the detection information or the reception information, the control unit calculates the first determination result by using the received detection information or the received reception information.

3. The information processing apparatus according to claim 1, wherein
the control unit determines whether a predetermined condition is satisfied based on the detection information and the reception information, or the first determination result,
when the predetermined condition is satisfied, the control unit calculates a comprehensive determination that is a second determination result, and transmits the comprehensive determination to a notification destination apparatus that is different from the another apparatus.

4. The information processing apparatus according to claim 1, wherein
the control unit changes an operation of the detection unit or the communication unit based on the first determination result.

5. The information processing apparatus according to claim 1, wherein
the control unit stops either one of the detection unit or the communication unit, and
activates the stopped detection unit or the stopped communication unit based on the detection information or the reception information.

6. The information processing apparatus according to claim 1, further comprising:
a storage unit that stores the detection information, the reception information or the first determination result, and
holds the stored information or the stored result even when a supply of an electric power from a power supply unit is stopped.

7. (canceled)

8. (canceled)

9. (canceled)

10. (canceled)

11. An information processing method for causing an information processing apparatus comprising:
detecting detection information that is information indicating an external state of the apparatus;
receiving reception information that is a determination result given by another apparatus;
calculating a first determination result that is a result acquired by determining a state of a surrounding of the apparatus based on the detection information and the reception information, and transmitting the first determination result to the another apparatus; and
activating a necessary function in an element for executing at least one of detection of the detection information, reception of the reception information, and transmission of the first determination result and stopping an unnecessary function thereof.

12. A computer readable non-transitory recording medium embodying a program, the program causing a computer to perform a method, the comprising:
detecting detection information that is information indicating an external state of the apparatus;
receiving reception information that is a determination result given by another apparatus;
calculating a first determination result that is a result acquired by determining a state of a surrounding of the apparatus based on the detection information and the reception information, and transmitting the first determination result to the another apparatus; and
activating a necessary function in an element for executing at least one of the above processing and stopping an unnecessary function thereof.
